(19) United States
(12) Patent Application Publication
(10) Pub. No.: US 2024/0191017 A1
(43) Pub. Date: Jun. 13, 2024

(54) ULTRAVIOLET-CURABLE COMPOSITION AND USE THEREOF

(71) Applicant: DOW TORAY CO., LTD., Shinagawa-Ku, Tokyo (JP)

(72) Inventors: Takuya OGAWA, Ichihara-shi, Chiba (JP); Yuki YOKOUCHI, Ichihara-shi, Chiba (JP)

(21) Appl. No.: 18/283,293

(22) PCT Filed: Mar. 15, 2022
(86) PCT No.: PCT/JP2022/011667

§ 371 Date: Dec. 12, 2023

(30) Foreign Application Priority Data
Mar. 26, 2021 (JP) 2021-052576

(51) Int. Cl. C08F 290/14; C09D 4/00; C09D 5/00

(52) U.S. Cl. CPC C08F 290/148; C09D 4/00; C09D 5/00

(57) ABSTRACT

Provided is a UV curable composition containing a silicon atom, that allows easy adjustment of the mechanical properties of the molded product obtained by curing, and excellent workability when applied to a substrate, even as a solvent-free type. The UV curable composition comprises: (A) 5 to 95 parts by mass of a compound having one or more acryloxy group in a molecule; and (B) 95 to 5 parts by mass of one or more type of organopolysiloxane without a UV curable functional group selected from (B1) and (B2); (B1) organopolysiloxane having three or more alkenyl groups in one molecule and no UV curable functional groups; (B2) organopolysiloxane having two or more alkenyl groups in one molecule but not having a UV curable functional group. The composition is substantially free of organic solvents, and the viscosity of the entire-composition measured at 25° C. using an E-type viscometer is 500 mPa·s or less.

### TECHNICAL FIELD

The present invention relates to a UV curable composition curable by chemical rays (actinic rays), for example ultraviolet light or electron beams, and in particular relates to UV curable compositions containing organosilicon compounds, preferably organopolysiloxanes, and in particular relates to UV curable compositions wherein cured products obtained therefrom have low viscosity, and excellent application properties. The curable composition of the present invention is suitable as an insulating material for electronic and electrical devices, and particularly as a material for use as a coating agent. Furthermore, the composition has excellent application properties and superior wettability to substrates, thus being useful as an injection molding material and inkjet printing material.

### BACKGROUND ART

Due to high heat resistance and excellent chemical stability, silicone resins have been used as coating agents, potting agents, insulating materials, and the like for electronic and electrical devices. Silicone resins include UV curable silicone compositions.

Touch panels are used in various display devices such as mobile devices, industrial equipment, car navigation systems, and the like. In order to improve detection sensitivity, electrical influence from light emitting sites such as light emitting diodes (LED) and organic light emitting devices (OLED) must be suppressed, and an insulating layer is usually placed between the light emitting part and the touchscreen.

On the other hand, thin display devices such as OLEDs have a structure in which a plurality of functional thin layers are stacked. In recent years, studies have been started in order to improve the overall reliability of display devices, especially flexible display devices, by laminating an insulating layer with high flexibility onto the touchscreen layer. In addition, the inkjet printing method has been adopted as a processing method for organic layers to improve productivity. Therefore, a material that can be processed by the inkjet printing method is required for the aforementioned insulating layer.

Japanese Unexamined Patent Application 2016-56330 discloses a UV curable organopolysiloxane composition containing a polysiloxane having a methacryloxy functional group, a polysiloxane having two or more acryloxy functional groups in one molecule, and a polysiloxane containing alkenyl groups at both ends, and also discloses a silicone gel cured product obtained from the composition.

In addition, International Patent Application Publication WO2019-130960 discloses a UV curable organopolysiloxane composition containing a polysiloxane having three or more acryloxy functional groups in a molecule and a polysiloxane having two or more alkenyl groups in a molecule. All of these compositions have high viscosity, so there are restrictions on the processing methods, and application by an injection molding method or inkjet method is not possible.

### RELATED ART DOCUMENTS

### Patent Documents

Patent Document 1: Japanese Unexamined Patent Application 2016-56330
Patent Document 2: WO2019/130960

### SUMMARY OF THE INVENTION

### Problem to be Solved by the Invention

As described above, several UV curable compositions containing an organopolysiloxane having an acryloxy functional group are well known, but there is still a need for UV curable compositions that allow easy adjustment of the mechanical properties of the cured material and have excellent workability, especially low viscosity, for application to substrates. The present invention attempts to provide a curable composition containing a silicon atom, that has both high adjustability of mechanical properties of the molded product obtained by curing, and excellent workability when applied to a substrate, even as a solvent-free type, and in particular, a UV curable composition.

### Means for Solving the Problem

The present invention was achieved by discovering that a UV curable composition, containing:
(A) 5 to 95 parts by mass of a compound having one or more acryloxy group in a molecule; and
(B) 95 to 5 parts by mass of one or more type of organopolysiloxane without a UV curable functional group selected from (B1) and (B2);
(B1) organopolysiloxane having three or more alkenyl groups in one molecule and no UV curable functional groups; and
(B2) an organopolysiloxane having two or more alkenyl groups in one molecule, a vinyl group content of 5% or more by mass, and not having a UV curable functional group,
will have low viscosity and excellent workability when applied to a substrate, even without using an organic solvent, and a cured product thereof will exhibit excellent mechanical property adjustment ability.

The present invention relates to a UV curable composition containing an organosilicon compound, particularly a UV curable organopolysiloxane composition, and the composition is cured by a UV curable functional group forming a bond. However, the curing method is not limited to UV irradiation, and an arbitrary method in which a UV curable functional group can cause a curing reaction can be used. For example, electron beam irradiation may be used to cure the composition of the present invention.

The UV curable composition of the present invention includes:
(A) 5 to 95 parts by mass of a compound having one or more acryloxy group in a molecule; and
(B) 95 to 5 parts by mass of one or more type of organopolysiloxane without a UV curable functional group selected from (B1) and (B2);
(B1) organopolysiloxane having three or more alkenyl groups in one molecule and no UV-curable functional groups;
(B2) organopolysiloxane having two or more alkenyl groups in one molecule but not having a UV curable functional group, where the amount of vinyl groups is 5% or more by mass,
wherein the composition substantially does not contain an organic solvent, and the viscosity of the entire composition measured at 25° C. using an E-type viscometer is 500 mPa·s or less.
   Note that unless otherwise specified herein, the viscosity of a substance is the value measured using an E-type viscometer at 25° C.

Component (A) in the curable composition may be a compound having one acryloxy group, or a mixture of two or more compounds having one acryloxy group.

The aforementioned component (A) may be a mixture of one or more compounds having one acryloxy group and one or more compounds having two or more acryloxy groups.

The aforementioned component (A) may be a compound having one or more acryloxy groups and not having a silicon atom.

Component (B) in the curable composition is preferably a straight chain organopolysiloxane expressed by the average composition formula:

RₐR′_{b}SiO_{(4-a-b)/2} (1)
(In the formula, R is an alkenyl group;
R′ is a group selected from monovalent hydrocarbon groups excluding alkenyl groups, hydroxyl groups, and alkoxy groups;
a and b are numbers that satisfy the following conditions: 1≤a+b<3 and 0.1≤a/(a+b)≤1.0, and at least two Rs are present in a molecule.)

The aforementioned component (B) is preferably one or more type of organopolysiloxane having 2 or more alkenyl groups in the molecule selected from a group consisting of: organopolysiloxanes expressed by the following formula (2):

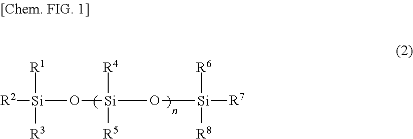

(where in the formula, of all R¹ to R⁸ groups, two or more alkenyl groups are present in the molecule; the other groups of R¹ to R⁸ are independently monovalent hydrocarbon groups that are unsubstituted or substituted with fluorine; and n is a numerical value that is 1 or more and 1000 or less); branched organopolysiloxanes expressed by the following average unit formula:

(R₃SiO_{1/2})ₑ(R₂SiO_{2/2})_{f}(RSiO_{3/2})_{g}(SiO_{4/2})ₕ (3)
(in the formula, R is independently a group selected from alkenyl groups and monovalent hydrocarbon groups that are unsubstituted or substituted with fluorine, at least two of all Rs are alkenyl groups, (g+h) is a positive number, e is 0 or a positive number, and f is a number within a range of 0 to 100); cyclic organopolysiloxanes expressed by the following formula (4):

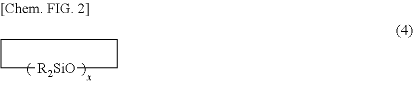

(in the formula, R independently represents a group selected from alkenyl groups and monovalent hydrocarbon groups that are unsubstituted or substituted with fluorine, x is an integer between 3 and 10, and at least 2 groups in the molecule are alkenyl groups); and
mixtures of these organopolysiloxanes.

The aforementioned component (B) preferably contains a branched organopolysiloxane having (RSiO_{3/2}) units.

The aforementioned component (B) is preferably an organopolysiloxane having 3 or more alkenyl groups per molecule.

The number of alkenyl groups in the aforementioned component (B) is preferably between 3 and 8.

The viscosity of the entire composition when measured at 25° C. using an E-type viscometer is preferably within a range of 5 to 60 mPa·s.

The viscosity of the entire composition when measured at 25° C. using an E-type viscometer is particularly preferably within a range of 5 to 30 mPa·s.

The present invention further provides an insulating coating agent containing the aforementioned UV curable composition. The UV curable composition of the present invention is useful as an insulating coating agent.

The present invention further provides a cured product of the aforementioned UV curable composition. Furthermore, the present invention also provides a method of using the cured product as an insulating coating layer.

The present invention further provides a display device such as a liquid crystal display, organic EL display, or organic EL flexible display that includes a layer containing a cured product of the aforementioned UV curable composition.

### DESCRIPTION OF THE PREFERRED EMBODIMENTS

A configuration of the present invention will be further described in detail below. The UV curable composition of the present invention includes as essential components for curing:
(A) 5 to 95 parts by mass of a compound having one or more acryloxy group in a molecule; and
(B) 95 to 5 parts by mass of one or more type of organopolysiloxane without a UV curable functional group selected from (B1) and (B2);
(B1) organopolysiloxane having three or more alkenyl groups in one molecule and no UV-curable functional groups;
(B2) organopolysiloxane having two or more alkenyl groups in one molecule but not having a UV curable functional group, where the amount of vinyl groups is 5% or more by mass,
and may contain components selected from photo-radical polymerization initiators and various additives as needed.
   However, the curable composition of the present invention is characterized by substantially not containing organic solvent.

In the present specification, the term “polysiloxane” refers to a siloxane unit (Si—O) with a degree of polymerization of two or more, in other words with an average of two or more Si—O bonds per molecule. Polysiloxanes include siloxane oligomers such as disiloxanes, trisiloxanes, tetrasiloxanes, and the like, as well as siloxane polymers with higher degrees of polymerization.

### (Component (A))

Component (A) is a compound having one or more acryloxy groups in a molecule. There is no restriction on the molecular structure as long as this object can be achieved, and the structure can be straight-chain, branched, cyclic, box-shaped, or any other type.

The aforementioned viscosity of component (A) at 25° C. is preferably 1 to 500 mPa·s, more preferably 1 to 100 mPa·s, particularly preferably 1 to 20 mPa·s, and most preferably 1 to 10 mPa·s.

Furthermore, the aforementioned component (A) contains 1 to 4 acryloxy groups per molecule, preferably 1 to 3 groups, and even more preferably 1 to 2 groups. In compounds with a plurality of acryloxy groups, there is no restriction on the positions of the acryloxy groups in the molecule, and the groups can be close together or far apart.

The aforementioned component (A) may be a single compound having one acryloxy group or a mixture of two or more compounds, each having one acryloxy group.

Furthermore, the aforementioned component (A) may be a mixture of one or more compounds having one acryloxy group and a compound having two or more acryloxy groups.

Furthermore, the aforementioned component (A) may be a mixture of one or more compounds having one acryloxy group and one or more compounds having two or more acryloxy groups.

Specific examples of compounds with one acryloxy group include isoamyl acrylate, octyl acrylate, dodecyl acrylate, lauryl acrylate, stearyl acrylate, diethylene glycol monoethyl ether acrylate, diethylene glycol monomethyl ether acrylate, 2-ethylhexyl acrylate, phenoxyethyl acrylate, diethylene glycol monophenyl ether acrylate, 4-hydroxybutyl acrylate, 2-hydroxypropyl acrylate, tetrahydrofurfuryl acrylate, isobornyl acrylate, dicyclopentanyl acrylate, dicyclopentenyl acrylate, 3,3,5-tricyclohexyl acrylate, polydimethylsiloxane with acryloxy functionality at one terminal, polydimethyldiphenylsiloxane copolymer with acryloxy functionality at one terminal, and the like, which may be used individually, or in a mixture of two or more types.

Compounds with one acryloxy group can be used individually, or in combinations of two or more groups, taking into consideration the viscosity of the compound, curing properties, hardness after curing, and the glass transition temperature. Of these, 2-ethylhexyl acrylate, isobornyl acrylate, and dicyclopentanyl acrylate can be preferably used.

Specific examples of compounds having two or more acryloxy groups include diethylene glycol diacrylate, triethylene glycol diacrylate, neopentyl glycol diacrylate, polyethylene glycol diacrylate, 1,4-bis(acryloyloxy)butane, 1,6-bis(acryloyloxy)hexane, 1,9-bis(acryloyloxy)nonane, trimethylolpropane triacrylate, tris(2-acryloyloxy)ethyl isoacrylate, pentaerythritol tetraacrylate, polydimethylsiloxane with acryloxy functionality on both terminals, polydimethyldiphenylsiloxane copolymer with acryloxy functionality on both terminals, polydimethyl(acryloxyalkylmethyl)siloxane copolymer with trimethylsilyl functionality on both terminals, polydimethyl(acryloxyalkylmethyl)siloxane copolymer with acryloxy functionality on both terminals, and the like.

Compounds with two or more acryloxy groups can be used individually, or in combinations of two or more groups, taking into consideration the viscosity of the compound, curing properties, compatibility with the aforementioned compounds having one acryloxy group, hardness after curing, and the glass transition temperature. Diethylene glycol diacrylate, 1,6-bis(acryloyloxy)hexane, trimethylolpropane triacrylate, and polydimethylsiloxane with acryloxy functionality on both terminals are preferably used, but compounds without silicon atoms, or in other words diethylene glycol diacrylate, 1,6-bis(acryloyloxy)hexane, and trimethylolpropane triacrylate are more preferably used.

Furthermore, in consideration of the aforementioned properties, these compounds having two or more acryloxy groups can be used in combination with the compounds having one acryloxy group. In this case, both can be combined in any ratio, but usually the ratio of [compounds with two or more acryloxy groups]/[compounds with one acryloxy group] ranges from 1/99 to 50/50 (mass ratio). This is because if the ratio of compounds with two or more acryloxy groups is too high, the cured material will tend to be hard and brittle.

### (Component (B))

Component (B) is an organopolysiloxane not having a UV curable functional group but having an alkenyl group in a molecule, specifically, one or more alkenyl group-containing polysiloxanes selected from the following (B1) and (B2).
(B1) organopolysiloxane having three or more alkenyl groups in one molecule and no UV curable functional groups;
(B2) organopolysiloxane having two or more alkenyl groups in one molecule but not having a UV curable functional group, where the amount of vinyl groups is 5% or more by mass.

The alkenyl groups in component (B) are preferably terminal alkenyl groups. Note that the amount of vinyl groups refers to the ratio of the mass of the vinyl group portion (CH₂═CH—) of all alkenyl groups included in the compound to the mass of the entire molecule.

The aforementioned component (B) can be a straight chain, branched, or cyclic organopolysiloxane expressed by the following formula:

RₐR′_{b}SiO_{(4-a-b)/2} (1)
(In the formula, R is an alkenyl group;
R′ is a group selected from monovalent hydrocarbon groups excluding alkenyl groups, hydroxyl groups, and alkoxy groups;
a and b are numbers that satisfy the following conditions: 1≤a+b<3 and 0.1≤a/(a+b)≤1.0, and at least two Rs are present in a molecule.)

Examples of the alkenyl groups represented by R in formula (1) include alkenyl groups with 2 to 8 carbon atoms, and specifically vinyl, allyl, butenyl, pentenyl, hexenyl, and octenyl groups. An alkenyl group with 3 to 8 carbon atoms is preferable, and of these, a hexenyl group is particularly preferably used.

Linear, branched, or cyclic organopolysiloxanes expressed by the average compositional formula above have at least two alkenyl groups (R) on average per molecule. The number of alkenyl groups is preferably 3 to 10, more preferably 3 to 8, and particularly preferably 4 to 8 per molecule on average.

R′ is a group selected from monovalent hydrocarbon groups, hydroxyl groups, and alkoxy groups, and monovalent hydrocarbon groups include unsubstituted monovalent hydrocarbon groups and fluorine-substituted monovalent hydrocarbon groups. The unsubstituted or fluorine-substituted monovalent hydrocarbon group is preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, hexyl, octyl, and other groups, but methyl groups and hexyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group.

The aforementioned organopolysiloxane expressed by formula (1) has a viscosity at 25° C. of 1 to 1000 mPa·s, or 1 to 500 mPa·s, but most preferably 1 to 200 mPa·s. The viscosity of the organopolysiloxane can be adjusted by changing the ratio of a and b in formula (1) as well as the molecular weight.

The organopolysiloxane expressed by formula (1) preferably has on average 3 to 50 silicon atoms per molecule, more preferably 4 to 20 atoms, and even more preferably 4 to 10 atoms.

In one preferred aspect, the organopolysiloxane of component (B) is a compound expressed by the following formula (2).

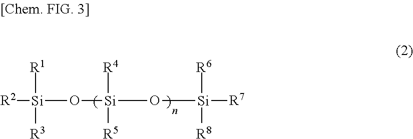

Similar to the aforementioned compound expressed by formula (1), the organopolysiloxane expressed by formula (2) has on average two or more alkenyl groups per molecule. In formula (2), of all R¹ to R⁸ groups, an average of two or more per molecule are alkenyl groups. The structure of the alkenyl group is not limited to an alkenyl group with a specific chemical structure as long as the structure has a carbon-carbon double bond. The alkenyl group is particularly preferably a terminal alkenyl group, and examples include alkenyl groups with 2 to 20 carbon atoms, such as vinyl groups, allyl groups, butenyl groups, pentenyl groups, hexenyl groups, heptenyl groups, octenyl groups, nonenyl groups, decenyl groups, undecenyl groups, dodecenyl groups, 4-vinylphenyl groups, and the like, but this is not a limitation. The alkenyl-containing group is particularly preferably a group selected from vinyl groups, allyl groups, hexenyl groups, and octenyl groups, but allyl groups and hexenyl group are particularly preferable.

In formula (2), R¹ to R⁸ other than the UV curable functional group are each independently an unsubstituted or fluorine-substituted monovalent hydrocarbon group, and preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group.

For n in formula (2), the viscosity of the organopolysiloxane expressed by formula (2) at 25° C. is preferably 1 to 1000 mPa·s, more preferably 1 to 500 mPa·s, particularly preferably 1 to 100 mPa·s. A person with ordinary skill in the art can easily determine the value of n without excess trial and error such that the viscosity of the organopolysiloxane of formula (2) is within the aforementioned viscosity range. In general, however, the number of silicon atoms per molecule is preferably 3 to 150, and particularly preferably between 3 to 50, in order for the compound of formula (2) to have the desired viscosity.

The number of alkenyl groups provided by the organopolysiloxane of formula (2), serving as component (B) is preferably, as a whole, 2 to 10 on average per molecule, more preferably 3 to 10, particularly preferably 3 to 8, and most preferably 4 to 8 groups. When the number of alkenyl groups is two, the aforementioned number n must be controlled so that the (CH═CH) group content is 5% or more by mass. The specific value of n in such cases is 12 or less.

The organopolysiloxane of formula (2) can be used as one type or as a mixture of two or more types. If two or more organopolysiloxanes are used as a mixture, the viscosity of the mixture at 25° C. is preferably the viscosity described above.

Furthermore, the aforementioned compound of formula (1) above may be a branched organopolysiloxane expressed by the following average unit formula (3). Average unit formula:

(R₃SiO_{1/2})ₑ(R₂SiO_{2/2})_{f}(RSiO_{3/2})_{g}(SiO_{4/2})ₕ (3)
(in the formula, R is independently a group selected from alkenyl groups and monovalent hydrocarbon groups that are unsubstituted or substituted with fluorine, at least two of all Rs are alkenyl groups, (g+h) is a positive number, e is 0 or a positive number, and f is a number within a range of 0 to 100).

The alkenyl groups and monovalent hydrocarbon groups are as defined above for formula (2). Furthermore, a preferred viscosity of the organopolysiloxane expressed by formula (3) is as specified above for the organopolysiloxane expressed by formula (2). Furthermore, the alkoxy groups and silanol groups may remain in the molecule in small amounts.

The organopolysiloxane expressed by formula (3) preferably has 4 to 30, especially 6 to 20 silicon atoms per molecule.

The number of alkenyl groups of the organopolysiloxane expressed by formula (3) is, as a whole, 2 to 10 on average per molecule, preferably 3 to 10, more preferably 3 to 8, and most preferably 4 to 8 groups. As described above, if the number of alkenyl groups is two, the number of silicon atoms and the number of substituent groups must be controlled, and the molecular design must be such that the vinyl group content is 5% by mass or more.

In one preferred aspect, component (B), and in particular the organopolysiloxane of formula (3) is a branched organopolysiloxane containing units expressed by (RSiO_{3/2}).

Specific examples of the straight-chain organopolysiloxane expressed by the aforementioned formula (1) and especially formula (2) include double terminated dimethylvinylsilylpolydimethylsiloxane, double terminated dimethylvinylsilylpolydimethyl/diphenylsiloxane copolymer, double terminated dimethylvinylsilylpolymethylphenylsiloxane, double terminated dimethylhexenylsilyl polydimethylsiloxane, double terminated trimethylsilyl polydimethyl/methylvinylsiloxane copolymer, double terminated dimethylvinylsilyl polydimethyl/methylvinylsiloxane copolymer, double terminated trimethylsilyl polydimethyl/methylhexenylsiloxane copolymer, double terminated dimethylvinylsilylpolydimethyl/methylhexenylsiloxane copolymer, double terminated dimethylhexenylsilylpolydimethyl/methylhexenylsiloxane copolymer, double terminated silanolpolymethylhexenylsiloxane, double terminated trimethylsilyl polymethylhexenylsiloxane, double terminated dimethylvinylsilyl polymethylhexenylsiloxane, and double terminated dimethylhexenylsilyl polymethylhexenylsiloxane.

Specific examples of branched organopolysiloxanes expressed by the aforementioned formula (1), especially formula (3) include polysiloxanes containing M^{Vi} (dimethylvinylsiloxy) units and T (methylsiloxy) units, polysiloxanes containing M^{Vi} units and Q (siloxy) units, polysiloxanes containing M^{Vi} units, M (trimethylsilyl) units and Q units, polysiloxanes containing M^{Vi} units, D (dimethylsiloxy) units and T units, polysiloxanes containing M^{Vi} units, M units, and T units, polysiloxanes containing M^{Vi} units and T^{Ph} (phenylsiloxy) units, polysiloxanes containing M^{Vi} units, M units and T^{Ph} units, polysiloxanes containing M^{Vi} units, D units and T^{Ph} units, polysiloxanes containing M^{Hex} (dimethylhexenylsiloxy) units and T units, polysiloxanes containing M^{Hex} units and Q units, polysiloxanes containing M^{Hex} units, M units and Q units, polysiloxanes containing M^{Hex}units, D units and T units, polysiloxanes containing M^{Hex} units, M units and T units, polysiloxanes containing M^{Hex} units, and T^{Ph} units, polysiloxanes containing M^{Hex} units, M units and T^{Ph} units, polysiloxanes containing M^{Hex} units, D units and T^{Ph} units, polysiloxanes containing D^{Hex} (methylhexenylsiloxy) units and T units, polysiloxanes containing M units, D^{Hex} units, and T units, polysiloxanes containing D^{Hex} units, D units, and T units, polysiloxanes containing D^{Hex} units and T^{Ph} units, polysiloxanes containing D^{Hex} units, D units, and T^{Ph} units, polysiloxanes containing M units, D^{Hex} units and T^{Ph} units, polysiloxanes containing M units, D^{Hex} units, and Q units, polysiloxanes containing M units and T^{Hex} (hexenylsiloxy) units, polysiloxanes containing M units, D units, and T^{Hex} units, polysiloxanes containing D units and T^{Hex} units, polysiloxanes containing T^{Hex} units, polysiloxanes containing T^{Hex} units, and Q units, polysiloxanes containing M units, T^{Hex} units and Q units, polysiloxanes containing T^{Hex} units, and T units, polysiloxanes containing T^{Hex} units and T^{Ph} units, and polysiloxanes containing M units, T^{Hex} units, and T^{Ph} units.

Furthermore, the aforementioned compound of formula (1) may be a cyclic organopolysiloxane expressed by formula (4)

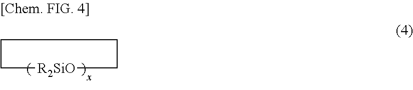

(in formula, R is independently a group selected from alkenyl groups and unsubstituted or fluorine-substituted monovalent hydrocarbon groups, x is an integer of 3 to 10, and at least two alkenyl groups are provided in the molecule).

The alkenyl group represented by R in formula (4) and the unsubstituted or fluorine-substituted monovalent hydrocarbon group are as defined for formula (1) above.

Furthermore, a preferred viscosity of the organopolysiloxane expressed by formula (4) is as specified above for the organopolysiloxane expressed by formula (1).

Specific examples of the cyclic organopolysiloxane expressed by formula (4) include 1,3,5,7-tetramethyl-1,3,5,7-tetravinylcyclotetrasiloxane, 1,3,5-trimethyl-1,3,5-trihexenylcyclotrisiloxane, 1,3,5,7-tetramethyl-1,3,5,7-tetrahexenylcyclotetrasiloxane, 1,3,5,7,9-pentamethyl-1,3,5,7,9-pentavinylcyclopentasiloxane, and 1,3,5,7,9-pentamethyl-1,3,5,7,9-pentahexenylcyclopentasiloxane.

The organopolysiloxane expressed by formulas (1), (2) to (4) can each be individually one type, or optionally a combination of two or more types as component (B). Component (B) is especially preferably one or more organopolysiloxane selected from the group consisting of the aforementioned organopolysiloxanes expressed by formula (2), branched organopolysiloxanes expressed by formula (3), and combinations thereof.

Compounds recommended as component (B) include one compound or a combination of two or more compounds selected from the group consisting of double terminated trimethylsilylpolydimethyl/methylhexenylsiloxane copolymer, double terminated dimethylvinylsilylpolydimethyl/methylhexenylsiloxane copolymer, double terminated dimethylhexenylsilylpolydimethyl/methylhexenylsiloxane copolymer, double terminated trimethylsilyl polymethylhexenylsiloxane, double terminated silanol polymethylhexenylsiloxane, polysiloxanes containing M units, D^{Hex} units and T units, polysiloxanes containing M units, D^{Hex} units and T^{Ph} units, polysiloxanes containing M^{Hex} units and T^{Ph} units, polysiloxanes containing M^{Hex} units, D units and T^{Ph} units, polysiloxanes containing M units and T^{Hex} units, polysiloxanes containing D units and T^{Hex} units, and polysiloxanes containing T^{Hex} units. Of these, polysiloxanes containing M units, D^{Hex} units and T^{Ph} units, polysiloxanes containing D^{Hex} units and T^{Ph} units, and polysiloxanes containing T^{Hex} units are particularly preferable.

### [Component (A)/(B) Mixing Ratio]

The mixing ratio of component (A) and component (B) is 5 to 95% by mass of component (A) and 95 to 5% by mass of component (B) relative to 100% by mass of the total amount of component (A) and component (B). When the ratio of components (A) and (B) is within this range, a material can be designed where the viscosity of the curable composition will be appropriate, favorable UV curability is maintained, and the mechanical properties of the resulting cured product, especially tensile elongation, will be favorable. The hardness of the cured material can easily be designed to be high by increasing the ratio of component (A). The preferred ratio of component (A) is 15% to 85% by mass, more preferably 20 to 80% by mass, and even more preferably 25 to 75% by mass, inclusively, of the total amount of components (A) and (B).

### [Organic Solvent-Free]

The UV curable composition of the present invention can achieve a suitable viscosity for the aforementioned coating agent without substantial use of an organic solvent and by using each of the aforementioned components, the UV curable composition substantially does not include an organic solvent. In the present specification, the phrase “essential not containing an organic solvent” means that the amount of organic solvent is less than 0.1 mass % of the total composition, preferably less than the analytical limit of analytical methods such as gas chromatography or the like. In the present invention, the desired viscosity can be achieved without the use of organic solvents by adjusting the molecular structure and molecular weight of component (A) and component (B).

In addition to the components (A) and (B) above, a photopolymerization initiator can be added to the UV curable composition of the present invention if desired. A photo-radical polymerization initiator can be used as the photoinitiator. The photoradical polymerization initiator generates free radicals by irradiating ultraviolet rays or electron beams, which trigger a radical polymerization reaction, to cure the composition of the present invention. When the composition of the present invention is cured by electron beam irradiation, a polymerization initiator is normally not required.

The photo-radical polymerization initiators are known to be broadly classified into photo-fragmentation and hydrogen abstraction types. However, the photo-radical polymerization initiator used in the composition of the present invention can be selected arbitrarily from those known in the technical field, and is not limited to any particular one. Examples of photoradical polymerization initiators include, but are not limited to, acetophenone, p-anisyl, benzyl, benzoin, benzophenone, 2-benzoylbenzoic acid, 4,4′-bis(diethylamino)benzophenone, 4,4′-bis(dimethylamino) benzophenone, benzoin methyl ether, benzoin isopropyl ether, benzoin isobutyl ether, benzoin ethyl ether, 4-benzoylbenzoic acid, 2,2′-bis(2-chlorophenyl)-4,4′,5,5′-tetraphenyl-1,2′-biimidazole, methyl 2-benzoylbenzoate, 2-(1,3-benzodioxol-5-yl)-4,6-bis(trichloromethyl)-1,3,5-triazine, 2-benzyl-2-(dimethylamino)-4′-morpholinobutyrophenone, (±)-camphorquinone, 2-chlorothioxanthone, 4,4′-dichlorobenzophenone, 2,2-diethoxyacetophenone, 2,2-dimethoxy-2-phenylacetophenone, 2,4-diethylthioxanthene-9-one, diphenyl(2,4,6-trimethylbenzoyl)phosphine oxide, ethyl(2,4,6-trimethylbenzoyl)phenyl phosphinate, 1,4-dibenzoylbenzene, 2-ethylanthraquinone, 1-hydroxycyclohexylphenyl ketone, 2-hydroxy-2-methylpropiophenone, 2-hydroxy-4′-(2-hydroxyethoxy)-2-methylpropiophenone, 2-isopropylthioxanthone, lithium phenyl(2,4,6-trimethylbenzoyl)phosphinate, 2-methyl-4′-(methylthio)-2-morpholinopropiophenone, 2-isonitrosopropiophenone, 2-phenyl-2-(p-toluenesulfonyloxy)acetophenone, and phenylbis(2,4,6-trimethylbenzoyl)phosphine oxide, and the like. Furthermore, in addition to the aforementioned compounds, examples of the photoradical polymerization initiators can include Omnirad (registered trademark) 651, 184, 1173, 2959, 127, 907, 369, 369E, and 379EG (alkylphenone photoradical polymerization initiator, IGM Resins B.V.); Omnirad (registered trademark) TPO H, TPO-L, and 819 (acyl phosphine oxide photoinitiators, IGM Resins B.V.); Omnirad (registered trademark) MBF and 754 (intramolecular hydrogen extraction type photoinitiators, IGM Resins B.V.); Irgacure (registered trademark) OXE01 and OXE02 (oxime ester non-associative polymerization initiator, BASF); and the like.

While the amount of the photoradical polymerization initiator added to the composition of the present invention is not particularly limited so long as the intended photoradical polymerization reaction or photo-curing reaction occurs, it is generally used at an amount of 0.01 to 5 mass %, and preferably 0.05 to 1 mass % relative to the total mass of the composition of the present invention.

Moreover, a photosensitizer may be used in combination with the aforementioned photoradical polymerization initiator. Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photoinitiator is feasible. While not limited thereto, exemplary known sensitizers include anthracene-based compounds, phenothiazine-based compounds, perylene-based compounds, cyanine-based compounds, melocyanine-based compounds, coumarin-based compounds, benzylidene ketone-based compounds, and (thio)xanthene- or (thio)xanthone-based compounds such as isopropylthioxanthone, 2,4-diethylthioxanthone, alkyl-substituted anthracenes, squarylium-based compounds, (thia)pyrylium-based compounds, porphyrin-based compounds, and the like, with any photosensitizer capable of being used in the curable composition according to the present invention.

The cured product obtained from the curable composition of the present invention will have the desired properties of the cured product and the curing speed of the curable composition depending on the molecular chain length and molecular structure of component (A) and component (B), the number of acryloxy groups per molecule in component (A), and the number of alkenyl groups per molecule in component (B), and the viscosity of the cured composition can be designed to achieve the desired value. Furthermore, the cured product obtained by curing the curable composition of the present invention is also included in the scope of the present invention. Furthermore, the shape of the cured product obtained from the composition of the present invention is not particularly limited, and it may be a thin film coating layer, may be a sheet-like molded product or the like, may be injected into a specific site in an uncured state and then cured to form a filling material, or may be used as a sealing material for a laminated body, display device, or the like or as an intermediate layer. The cured product obtained from the composition of the present invention is preferably in the form of an injection molded protective adhesive layer and a thin film coating layer, and particularly preferably is a thin film insulating coating layer.

The curable composition of the present invention is suitably used as a coating agent or potting agent, particularly as an insulating coating agent or potting agent for an electronic device or electrical device.

The cured product obtained by curing the curable composition of the present invention is characterized by excellent mechanical properties, especially tensile properties. When evaluated at a tensile speed of 50 mm/minute at 25° C. using a 0.5 mm thick test piece, the tensile elongation is usually 20% or more. By optimizing the curable composition, the tensile elongation of the cured product can be increased to 100% or more, and can be used as a layer forming material for a flexible display.

If desired, the cured product obtained by curing the curable composition of the present invention can be designed to have a dielectric constant of less than 3.0, or less than 2.8, or the like, and the curable composition of the present invention can also be used to form a coating layer having a low dielectric constant.

If the curable composition of the present invention is used as an injection molding material and a coating agent, the viscosity of the entire composition is 500 mPa·s or less at 25° C., as measured using an E-type viscometer, in order for the composition to have suitable flowability and workability for application to the substrate. When used as an injection molding material, the viscosity is preferably 200 mPa·s or less, especially 80 mPa·s or less, but this depends on the gap into which it is to be injected. On the other hand, when used as a coating agent, the preferred viscosity range is 5 to 60 mPa·s, more preferably 5 to 30 mPa·s, and especially 5 to 20 mPa·s, considering application by the inkjet printing method, which is rapidly becoming more practical. The viscosity of the entire curable composition can be adjusted to the desired viscosity by using compounds with a preferred viscosity as each component so that the viscosity of the entire composition has the desired viscosity.

### [Component (C)]

When the UV curable organopolysiloxane composition of the present invention is applied to a surface of a substrate as a coating agent using an arbitrary method, in order to improve the wettability of the composition on the substrate and to form a defect-free coating film, component (C) selected from the following can be further added to the composition of the present invention, containing the aforementioned components. The use of inkjet printing is particularly preferred as a method for coating the composition of the present invention on a substrate. Therefore, component (C) is a component that improves the wettability of the UV curable organopolysiloxane composition of the present invention on a substrate, and particularly significantly improves inkjet printing properties. Component (C) is at least one type of compound selected from a group consisting of the following (C1), (C2), and (C3).

### (i) Component (C1)

Component (C1) is a nonionic surfactant that does not contain a silicon atom and is not acrylic, in other words, a nonacrylic nonionic surfactant. “Nonacrylic” means that the surfactant does not have a (meth)acrylate group in a molecule thereof. Examples of surfactants that can be used as component (C1) include glycerol fatty acid esters, sorbitan fatty acid esters, polyoxyethylene alkyl ethers, polyoxyethylene alkyl phenyl ethers, alkyl glycosides, acetylene glycol polyether, and other organic nonionic surfactants, fluorine-based nonionic surfactants, and the like, and one or a combination of two or more types thereof can be used. Specific examples of component (C1) include the EMULGEN Series and RHEODOL series manufactured by Kao Corporation, SURFYNOL 400 series manufactured by Evonik Industries AG, and OLFINE E series manufactured by Nissin Chemical Co., Ltd. as organic nonionic surfactants, and FC-4400 series manufactured by 3M and MEGAFACE 550 and 560 series manufactured by DIC Corporation as fluorine-based nonionic surfactants.

Of these, SURFYNOL400 series and OLFINE E series, which are alkynol polyethers, are particularly preferred.

(ii) Component (C2) is a nonionic surfactant containing a silicon atom and having an HLB value of 4 or less. Herein, the HLB value is a value that expresses the degree of affinity of a surfactant to water and organic compounds, and herein, a value defined by the Griffin method (20×sum of the formula weight of the hydrophilic portion/molecular weight) is used as the HLB value. Silicone polyether having a polyether as a hydrophilic portion, glycerol silicone having a (di)glycerol derivative as a hydrophilic portion, carbinol silicones having a hydroxyethoxy group as a hydrophilic portion, and the like are known silicon-containing nonionic surfactants. Of these surfactants, those with an HLB value of 4 or less, in other words, those with a hydrophilic portion mass fraction of 20 mass % or less, are preferably used in the composition of the present invention. Of these, carbinol silicone is particularly preferred.

(iii) Component (C3) is a silicone oil having a viscosity of 90 mPa·s or less at 25° C. Examples of silicone oils include both-end terminated trimethylsilyl-polydimethylsiloxane, both-end terminated dimethylvinylsilyl-polydimethylsiloxane, both-end terminated trimethylsilyl-dimethylsiloxy/methylvinylsiloxy copolymers, both-end terminated dimethylvinylsilyl-dimethylsiloxy/methylvinylsiloxy copolymers, both-end terminated trimethylsilyl-dimethylsiloxy/methylphenylsiloxy copolymers, both-end terminated trimethylsilyl-dimethylsiloxy/diphenylsiloxy copolymers, both-end terminated dimethylvinylsilyl-dimethylsiloxy/methylphenylsiloxy copolymers, both-end terminated dimethylvinylsilyl-dimethylsiloxy/diphenylsiloxy copolymers, and the like. Both-end terminated trimethylsilyl-polydimethylsiloxane and both-end terminated dimethylvinylsilyl-polydimethylsiloxane can be preferably used. A preferred viscosity range of the silicone oil is 2 to 50 mPa·s. A more preferred range is 2 to 30 mPa·s, and an even more preferred viscosity range is 5 to 20 mPa·s. Note that viscosity values herein were measured at 25° C. using a rotational viscometer described in the Examples.

Components (C1) through (C3) described above can be one or a combination of two or more thereof. The amount of component (C) in the curable composition is not particularly limited, but the total of components (C1) to (C3) (collectively referred to as component (C)) is preferably 0.05 mass % or more and 1 mass % or less relative to the total amount of 100 mass % of component (A) and component (B) described above. This is because if the amount of component (C) is less than 0.05 mass % relative to a total amount of 100 mass % of components (A) and (B), an effect of improving the wettability of the curable composition to a substrate may not be sufficient, and if the amount of component (C) exceeds 1 mass % relative to total amount of 100 mass % of components (A) and (B), there is a risk that component (C) may bleed out from a cured product after curing.

As component (C), a silicone oil of component (C3) is preferably used alone, or component (C3) is preferably used in combination with one or more components selected from a group consisting of component (C1) and component (C2). Component (C3) is preferably used alone as component (C).

### <Other Additives>

In addition to the aforementioned components, an additional additive may be added to the composition of the present invention if desired. Examples of additives include, but are not limited to, those described below.

### [Adhesion Imparting Agent]

An adhesion promoter can be added to the composition of the present invention to improve adhesion and close-fitting properties to a substrate in contact with the composition. When the curable composition of the present invention is used for applications such as coating agents, sealing materials, and the like that require adhesion or close-fitting properties to a substrate, an adhesion imparting agent is preferably added to the curable composition of the present invention. An arbitrary known adhesion promoter can be used, so long as the adhesion promoter does not interfere with a curing reaction of the composition of the present invention.

Examples of such adhesion promoters that can be used in the present invention include: organosilanes having a trialkoxysiloxy group (such as a trimethoxysiloxy group or a triethoxysiloxy group) or a trialkoxysilylalkyl group (such as a trimethoxysilylethyl group or triethoxysilylethyl groups) and a hydrosilyl group or an alkenyl group (such as a vinyl group or an allyl group), or organosiloxane oligomers having a linear structure, branched structure, or cyclic structure with approximately 4 to 20 silicon atoms; organosilanes having a trialkoxysiloxy group or a trialkoxysilylalkyl group and a methacryloxyalkyl group (such as a 3-methacryloxypropyl group), or organosiloxane oligomers having a linear structure, branched structure, or cyclic structure with approximately 4 to 20 silicon atoms; organosilanes having a trialkoxysiloxy group or a trialkoxysilylalkyl group and an epoxy group-bonded alkyl group (such as a 3-glycidoxypropyl group, a 4-glycidoxybutyl group, a 2-(3,4-epoxycyclohexyl)ethyl group, or a 3-(3,4-epoxycyclohexyl)propyl group), or organosiloxane oligomers having a linear structure, branched structure, or cyclic structure with approximately 4 to 20 silicon atoms; organic compounds having two or more trialkoxysilyl groups (such as trimethylsilyl groups or triethoxysilyl groups); reaction products of aminoalkyltrialkoxysilane and epoxy group-bonded alkyltrialkoxysilane, and epoxide group-containing ethyl polysilicate. Specific examples thereof include vinyl trimethoxysilane, allyl trimethoxysilane, allyl triethoxysilane, hydrogen triethoxysilane, 3-glycidoxypropyl trimethoxysilane, 3-glycidoxypropyl triethoxysilane, 2-(3,4-epoxycyclohexyl)ethyl trimethoxysilane, 3-methacryloxypropyl trimethoxysilane, 3-methacryloxypropyl triethoxysilane, 1,6-bis(trimethoxysilyl)hexane, 1,6-bis(triethoxysilyl)hexane, 1,3-bis[2-(trimethoxysilyl)ethyl]-1,1,3,3-tetramethyldisiloxane, reaction products of 3-glycidoxypropyl triethoxysilane and 3-aminopropyl triethoxysilane, condensation reaction products of a methylvinyl siloxane oligomer blocked with a silanol group and a 3-glycidoxypropyl trimethoxysilane, condensation reaction products of a methylvinyl siloxane oligomer blocked with a silanol group and a 3-methacryloxypropyl triethoxysilane, and tris(3-trimethoxysilylpropyl)isocyanurate.

The amount of the adhesion promoter to be added to the curable composition of the present invention is not particularly limited. However, since it does not promote curing properties of the curable composition or discoloration of a cured product, the amount is preferably within a range of 0.01 to 5 parts by mass, or within a range of 0.01 to 2 parts by mass, relative to a total of 100 parts by mass of components (A) and (B).

### [Additional Optional Additives]

Another additive may be added to the composition of the present invention in addition to or in place of the adhesion imparting agent described above, if desired. Examples of additives that can be used include leveling agents, silane coupling agents not included in those listed above as adhesion imparting agents, UV absorbers, antioxidants, polymerization inhibitors, fillers (reinforcing fillers, insulating fillers, thermal conductive fillers, and other functional fillers), and the like. If necessary, an appropriate additive can be added to the composition of the present invention. Furthermore, a thixotropy imparting agent may also be added to the composition of the present invention if necessary, particularly when used as a potting agent or sealing agent.

### [Application]

The UV curable organopolysiloxane composition of the present invention can be cured not only by ultraviolet rays but also by electron beams, which is another aspect of the present invention.

The curable composition of the present invention has low viscosity, and is particularly useful as a material for forming an insulating layer for various articles, particularly electronic and electrical devices. The composition of the present invention can be applied on a substrate or sandwiched between two substrates, at least one of which includes a material that allows ultraviolet rays or electron beams to pass, and the composition can be cured by irradiating ultraviolet rays or electron beams to form an insulating layer. In this case, the composition of the present invention can be patterned when applied to a substrate, and then the composition can be cured. Alternatively, the composition can be applied to a substrate, and cured and uncured portions can be left during curing by ultraviolet rays or electron beam irradiation. Thereafter, an uncured portion can be removed with a solvent to form an insulating layer having a desired pattern. In particular, when the cured layer of the present invention is an insulating layer, the layer can be designed to have a low dielectric constant of less than 3.0.

The curable composition of the present invention provides favorable transparency of the cured product obtained therefrom, and is particularly suitable as a material for forming an insulating layer for touch panels and displays and other display devices. In this case, an arbitrary desired pattern may be formed as described above if necessary on the insulating layer. Therefore, a display device such as touch panel, display, or the like containing an insulating layer obtained by curing the UV curable organopolysiloxane composition of the present invention is also an aspect of the present invention.

Furthermore, the curable composition can also be used to form an insulating coating layer (insulating film) by curing after coating an article. Therefore, the composition of the present invention can be used as an insulating coating agent. Furthermore, a cured product formed by curing the curable composition of the present invention can be used as an insulating coating layer.

An insulating film formed from the curable composition of the present invention can be used for various applications. In particular, use is possible as a component of an electronic device or as a material used in a process of manufacturing the electronic device. Electronic devices include semiconductor devices, magnetic recording heads, and other electronic apparatuses. For example, the curable composition of the present invention can be used in an insulating film of a semiconductor device, such as an LSI, system LSI, DRAM, SDRAM, RDRAM, D-RDRAM, or a multi-chip module multilayer circuit board, an interlayer insulating film for a semiconductor, an etch stopper film, a surface protection film, a buffer coat film, a passivation film in LSI, a cover coat for a flexible copper cladding plate, a solder resistant film, and a surface protection film for an optical device.

Furthermore, the UV curable composition of the present invention can be used as a coating agent, or as a potting agent, and particularly as an insulating potting agent for electronic devices and electrical devices.

The composition of the present invention can be used as a material for forming a coating layer on a surface of a substrate, particularly using an inkjet printing method. In this case, the composition of the present invention particularly preferably contains component (C) described above.

The present invention is further described below based on Examples, but the present invention is not limited to the Examples below.

### Examples

The UV curable composition of the present invention and a cured product thereof of the present invention will be described below in further detail using examples. Furthermore, measurements and evaluations in the Examples and Comparative Examples were conducted as follows.

### [Viscosity of Curable Composition]

The viscosity (mPa·s) of the composition at 25° C. was measured using a rotary viscometer (E type viscometer VISCONIC EMD produced by TOKIMEC CORPORATION).

### [Appearance of Curable Composition and Cured Product Obtained Therefrom]

The appearance of the curable composition and the cured product obtained therefrom were observed and visually evaluated.

### [Preparation of Curable Composition]

Each material at the amounts listed in Table 1 below was placed in a brown plastic container and mixed well, using a planetary mixer to prepare the curable composition.

### [Wettability of Curable Composition on Substrate (Contact Angle of Composition)]

Two microliters of the curable composition was dripped onto a silicon nitride coated glass substrate, and the contact angle of the curable composition immediately after dripping and 15 seconds after dripping was measured at 23° C. using a contact angle (units: °) measuring device DM-700 manufactured by Kyowa Interface Science Co., Ltd.

### [UV Curability of Curable Composition]

Approximately 0.05 g of the curable composition was placed on a glass sample stand, and the gap between the shear rotation fixture and the sample stand was set at 100 micrometers. The storage modulus was measured by applying shear stress to the sample (shear strain 0.05%, frequency 1 Hz) while irradiating 405 nm light for 30 seconds (integrated light intensity: 2 J/cm2) using MCR302 produced by Anton Paar. The elastic modulus value (units: Pa) was recorded approximately 2 minutes after the start of irradiation, when the value becomes almost constant.

### [Curing of Curable Composition and Preparation of Tensile Test Piece]

Approximately 0.2 g of curable composition was injected between two glass substrates with a 0.5 mm thick spacer interpose therebetween. By irradiating LED light having a wavelength of 405 nm at an energy intensity of 2 J/cm² from the outside through one glass substrate, the composition was cured to fabricate a plate-shaped cured product having a length of 50 mm and a thickness of 0.5 mm. The short pieces were trisected to fabricate 10×50×0.5 (thick) mm³ strip-shaped tensile samples

### [Tensile Properties of Organopolysiloxane Cured Product]

Tensile test samples made from the aforementioned organopolysiloxane cured product were evaluated at a test speed of 50 mm/min at 25° C. using an Autograph AGS-X manufactured by Shimadzu Corporation. Elongation at break (units: %) was recorded as the measured value.

### [Curing of Curable Composition and Preparation of Sample for Dielectric Constant Measurement]

A mold having a thickness of 1 mm having circular holes with an inner diameter of 40 mm was placed on a PET film coated with a fluoropolymer release agent, and approximately 1.3 g of the curable composition was poured into a hole thereof. A PET film similar to that described above was placed over the composition, and a 10 mm thick glass plate was placed thereon. By irradiating an LED light having a wavelength of 405 nm at an energy amount of 2 J/cm² from above, the composition was cured to prepare a disk-shaped organopolysiloxane cured product having a diameter of 40 mm and a thickness of 1 mm.

### [Dielectric Constant of Organopolysiloxane Cured Product]

A tin foil having a diameter of 33 mm and a thickness of 0.007 mm was pressed onto both surfaces of the prepared organopolysiloxane cured product. In order to improve close fitting properties between the cured product and the foil, a small amount of silicone oil, if necessary, was used for pressing. The capacitance at room temperature and 100 KHz was measured by an E4990A precision impedance analyzer manufactured by Keysight Technologies to which a parallel plate electrode having a diameter of 30 mm was connected. The dielectric constant was calculated using measured capacitance values, separately measured thicknesses of the cured product, and electrode area values.

### Examples and Comparative Examples

The UV curable compositions were prepared at the compositions (parts by mass) shown in Table 1 and Table 2 using each of the following components.
(A1) Isobornyl acrylate (monofunctional)
(A2) 2-Ethylhexyl acrylate (monofunctional)
(A3) Polydimethylsiloxane with acryloxy functionality on both terminals (bifunctional): average degree of polymerization 16
(A4) Dodecyl acrylate (monofunctional)
(A5) Diethylene glycol diacrylate (bifunctional)
(A6) 1,6-bis(acryloyloxy)hexane (bifunctional)
(A7) Trimethylolpropane triacrylate (trifunctional)
(a) Isobornyl methacrylate (monofunctional)
(B1-1) Branched polydimethylsiloxane with 4 dimethylvinylsiloxy terminal groups (4 functional groups)
(B1-2) Silanol polymethylhexenylsiloxane (average number of functional groups: 9)
(B1-3) Branched polysiloxane expressed by M_{0.06}M^{Vi}_{0.55}Q_{0.39} (average number of functional groups: 10)
(B1-4) Polyhexenyl silsesquioxane (average number of functional groups: 7.7)
(B1-5) Branched polysiloxane expressed by M_{0.18}D^{Hex}_{0.50}T^{Ph}_{0.32} (average number of functional groups: 8)
(B2) Polydimethylsiloxane with dimethylvinyl groups at both terminals (number of functional groups: 2; (CH═CH) group content: 8.3%)
(b) Polydimethylsiloxane with dimethylvinyl groups at both terminals (number of functional groups: 2; (CH═CH) group content: 0.4%)
(C) DOWSIL™ SH 200 Fluid (20 cSt) (manufactured by Dow Chemical Company)
(D) OMNIRAD TPO-L (manufactured by IGM Resins)
(E) Dibutylhydroxytoluene

TABLE 1

| | | | | | | | | | Comparative | \|Comparative |
|---|---|---|---|---|---|---|---|---|---|---|
| Component | Example 1 | Example 2 | Example 3 | Example 4 | Example 5 | Example 6 | Example 7 | Example 8 | Example 1 | Example 2 |
| (A1) | 25.0 | 25.0 | 25.0 | | | 40.0 | 47.0 | | | |
| (A2) | | | | 25.0 | | | | | | 25.0 |
| (a) | | | | | | | | | 25.0 | |
| (A3) | | | | | 25.0 | | | | | |
| (A4) | | | | | | | | 47.0 | | |
| (B1-1) | | 74.2 | | | | | | | | |
| (B1-2) | | | 74.2 | 74.2 | 74.2 | 59.2 | | | 74.2 | |
| (B1-3) | | | | | | | 47.0 | 47.0 | | |
| (B2) | 74.2 | | | | | | | | | |
| (b) | | | | | | | | | | 74.2 |
| (D) | 0.5 | 0.5 | 0.5 | 0.5 | 0.5 | 0.5 | 5.7 | 5.7 | 0.5 | 0.5 |
| (E) | 0.3 | 0.3 | 0.3 | 0.3 | 0.3 | 0.3 | 0.3 | 0.3 | 0.3 | 0.3 |
| Total | 100.0 | 100.0 | 100.0 | 100.0 | 100.0 | 100.0 | 100.0 | 100.0 | 100.0 | 100.0 |
| Appearance | Trans- | Trans- | Trans- | Trans- | Trans- | Trans- | Trans- | Trans- | Trans- | Trans- |
| of curable | parent | parent | parent | parent | parent | parent | parent | parent | parent | parent |
| composition | | | | | | | | | | |
| Viscosity of | 7 | 97 | 20 | 12 | 30 | 16 | 14 | 13 | 21 | 150 |
| composition | | | | | | | | | | |
| Appearance | Trans- | Semi- | Trans- | Trans- | Trans- | Trans- | Trans- | Trans- | Did not | Did not |
| of cured | parent | trans- | parent | parent | parent | parent | parent | parent | cure | cure |
| product | | parent | | | | | | | | |
| Storage | 2 × 10³ | 3 × 10⁵ | 2 × 10⁵ | 2 × 10⁵ | 1 × 10⁵ | 5 × 10⁵ | 1 × 10⁷ | 4 × 10⁴ | — | — |
| Elastic | | | | | | | | | | |
| Modulus | | | | | | | | | | |
| of Cured | | | | | | | | | | |
| Product | | | | | | | | | | |

TABLE 2

| Component | Example 9 | Example 10 | Example 11 | Example 12 | Example 13 | Example 14 | Example 15 | Example 16 | Example 17 |
|---|---|---|---|---|---|---|---|---|---|
| (A1) | 40.0 | 33.8 | 33.8 | 37.5 | 50.0 | 45.0 | 40.0 | 60.0 | 60.0 |
| (A2) | | 11.2 | 11.2 | 12.5 | | 5.0 | 6.6 | | |
| (A5) | | 5.0 | | | | | | | |
| (A6) | | | 5.0 | | | | | | |
| (A7) | | | | | | | 3.4 | | |
| (B1-4) | 59.2 | 49.2 | 49.2 | 49.2 | | | | 39.2 | 39.2 |
| (B1-5) | | | | | 49.2 | 49.2 | 49.2 | | |
| (C) | | | | | | | | | 0.3 |
| (D) | 0.5 | 0.5 | 0.5 | 0.5 | 0.5 | 0.5 | 0.5 | 0.5 | 0.5 |
| (E) | 0.3 | 0.3 | 0.3 | 0.3 | 0.3 | 0.3 | 0.3 | 0.3 | 0.3 |
| Total | 100.0 | 100.0 | 100.0 | 100.0 | 100.0 | 100.0 | 100.0 | 100.0 | 100.3 |
| Appearance of | Transparent | Transparent | Transparent | Transparent | Transparent | Transparent | Transparent | Transparent | Transparent |
| curable | | | | | | | | | |
| composition | | | | | | | | | |
| Viscosity of | 33 | 18 | 18 | 18 | 22 | 19 | 20 | 19 | 19 |
| composition | | | | | | | | | |
| Appearance of | Transparent | Transparent | Transparent | Transparent | Transparent | Transparent | Transparent | Transparent | Transparent |
| cured product | | | | | | | | | |
| Contact angle of | | | | | | | | 15 | 14 |
| composition: | | | | | | | | | |
| Immediately after | | | | | | | | | |
| dripping | | | | | | | | | |
| Contact angle of | | | | | | | | 8 | <5 |
| composition: 15 | | | | | | | | | |
| seconds after | | | | | | | | | |
| dripping | | | | | | | | | |
| Storage Elastic | 1 × 10⁶ | 8 × 10⁶ | 5 × 10⁶ | 2 × 10⁶ | 2 × 10⁶ | 4 × 10⁵ | 2 × 10⁶ | 5 × 10⁷ | 5 × 10⁷ |
| Modulus of Cured | | | | | | | | | |
| Product | | | | | | | | | |
| Tensile Elongation | 72 | 42 | 42 | 62 | 170 | 76 | 105 | | |
| of Cured Product | | | | | | | | | |
| Dielectric constant | | | | | | | | 2.5 | |
| of cured product | | | | | | | | | |

As shown in Table 1 and Table 2, the UV curable compositions of the present invention (Examples 1 to 17) have viscosities at 25° C. that are suitable for application onto substrates as injection molding materials and coating agents, especially by inkjet printing. Furthermore, the composition has favorable wettability to the substrate, but the addition of component (C) can further improve the wettability. Furthermore, the cured product obtained from the composition of the present invention has high tensile elongation and excellent flexibility. In addition, a cured product obtained from the composition of the present invention exhibits low dielectric properties. On the other hand, a composition that does not contain component (A) (Comparative Example 1) and a composition with low alkenyl content of component (B) (Comparative Example 2) have insufficient UV curability, and cured products cannot be obtained under standard industrial curing conditions.

### INDUSTRIAL APPLICABILITY

The UV curable composition of the present invention is particularly suitable for the applications described above, and particularly as a material for forming an insulating layer for touch panels and displays and other display devices, and particularly flexible displays.

1. A UV curable composition, comprising:
(A) 5 to 95 parts by mass of a compound having one or more acryloxy group in a molecule; and
(B) 95 to 5 parts by mass of one or more type of organopolysiloxane without a UV curable functional group selected from (B1) and (B2);
(B1) organopolysiloxane having three or more alkenyl groups in one molecule and no UV curable functional groups;
(B2) organopolysiloxane having two or more alkenyl groups in one molecule but not having a UV curable functional group, where the amount of vinyl groups is 5% or more by mass;
wherein the composition is substantially free of organic solvents, and the viscosity of the composition measured at 25° C. using an E-type viscometer is 500 mPa·s or less.

2. The UV curable composition according to claim 1, wherein component (A) is a compound having one acryloxy group, or a mixture of two or more compounds having one acryloxy group.

3. The UV curable composition according to claim 1, wherein component (A) is a mixture of one or more compound having one acryloxy group and one or more compound having two or more acryloxy groups.

4. The UV curable composition according to claim 1, wherein component (A) is a compound having one or more acryloxy groups and not having a silicon atom.

5. The UV curable composition according to claim 1, wherein component (B) is a straight chain, branched, or cyclic organopolysiloxane expressed by the average composition formula:
RₐR′_{b}SiO_{(4-a-b)/2} (1)
where in the formula (1), R is an alkenyl group;
R′ is a group selected from monovalent hydrocarbon groups excluding alkenyl groups, hydroxyl groups, and alkoxy groups;
a and b are numbers that satisfy the following conditions: 1≤(a+b)<3 and 0.1≤(a/(a+b) 1.0), and
at least two Rs are present in a molecule.

6. The UV curable composition according to claim 1, wherein the organopolysiloxane of component (B) is one or more type of organopolysiloxane having 2 or more alkenyl groups in the molecule, selected from a group consisting of: organopolysiloxanes expressed by the following formula (2): 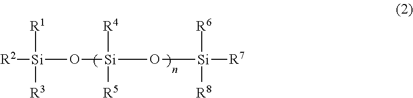
where in the formula (2), of all R¹ to R⁸ groups, two or more alkenyl groups are present in the molecule; the other groups of R¹ to R⁸ are independently monovalent hydrocarbon groups that are unsubstituted or substituted with fluorine; and n is a numerical value that is 1 or more and 1000 or less;
branched organopolysiloxanes expressed by the following average unit formula:
(R₃SiO_{1/2})ₑ(R₂SiO_{2/2})_{f}(RSiO_{3/2})_{g}(SiO_{4/2})ₕ (3)
where in the formula (3), R is independently a group selected from alkenyl groups and monovalent hydrocarbon groups that are unsubstituted or substituted with fluorine, at least two of all Rs are alkenyl group, (g+h) is a positive number, e is 0 or a positive number, and f is a number within a range of 0 to 100;
cyclic organopolysiloxanes expressed by the following formula (4): 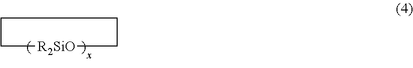
wherein in the formula (4), R independently represents a group selected from alkenyl groups and monovalent hydrocarbon groups that are unsubstituted or substituted with fluorine, x is an integer from 3 to 10, and at least 2 groups in the molecule are alkenyl groups; and
mixtures of these organopolysiloxanes.

7. The UV curable composition according to claim 1, wherein component (B) includes a branched organopolysiloxane having (RSiO₃/2) units.

8. The UV curable composition according to claim 1, wherein component (B) is an organopolysiloxane having 3 or more alkenyl groups in one molecule.

9. The UV curable composition according to claim 1, wherein the alkenyl group in component (B) in the curable composition is an alkenyl group with 3 to 8 carbon atoms.

10. The UV curable composition according to claim 1, wherein the viscosity of the composition measured at 25° C. using an E-type viscometer is 5 to 60 mPa·s.

11. The UV curable composition according to claim 10, wherein the viscosity of the composition measured at 25° C. using an E-type viscometer is 5 to 30 mPa·s.

12. An insulating coating agent, comprising: the UV curable composition according to claim 1.

13. A cured product of the UV curable composition according to claim 1.

14. A method of using an insulating coating layer of a cured product of the UV curable composition according to claim 1.

15. A display device, comprising a layer containing a cured product of the UV curable composition according to claim 1.
